(19) United States
(12) Patent Application Publication
(10) Pub. No.: US 2019/0348725 A1
(43) Pub. Date: Nov. 14, 2019

(54) WALL STRUCTURE OF BATTERY CELL, BATTERY SUB-MODULE, BATTERY MODULE, OR A BATTERY SYSTEM

(71) Applicant: SAMSUNG SDI CO., LTD., Yongin-si, Gyeonggi-do (KR)

(72) Inventor: Andrej GOLUBKOV, Graz (AT)

(21) Appl. No.: 16/464,669

(22) PCT Filed: Nov. 28, 2017
(86) PCT No.: PCT/KR2017/013641

§ 371 Date: May 28, 2019

(30) Foreign Application Priority Data
Nov. 29, 2016 (EP) 16201061.5
Nov. 20, 2017 (KR) 10-2017-0154946

(51) Int. Cl. H01M 10/653; H01M 10/658; H01M 2/02

(52) U.S. Cl. CPC H01M 10/653; H01M 10/658; H01M 2/0287; H01M 2/0285; H01M 2/0262

(57) ABSTRACT

A wall structure according to an exemplary embodiment of the present invention as a wall structure of one case among a battery cell, a battery sub-module, a battery module, and a battery system includes a multi-layered structure having a first layer toward an inside of the case, the case, a third layer toward an outside of the case, and a second layer between the first layer and the third layer, wherein the first layer is configured to electrically isolate the second layer from the inside of the case, the second layer includes an ablative material and is configured to act as a heat shield for the third layer, and the third layer has higher thermal conductivity than the second layer.

### TECHNICAL FIELD

The present invention relates to a wall structure of one among a battery cell, a battery sub-module, a battery module, and a battery system, and particularly relates to a wall structure including a multi-layered structure. Also, the present invention relates to a battery cell, a battery sub-module, a battery module, and a battery system with improved heat dissipation characteristics and improved resistance to an electric arc while having a multi-layered wall structure.

### BACKGROUND ART

A rechargeable or secondary battery differs from a primary battery that only irreversibly converts chemical materials into an electrical energy in that a charging and discharging may be repeated. A low-capacity rechargeable battery is used as a power source of a small electronic device such as a mobile phone, a laptop computer, and a camcorder, and a high-capacity rechargeable battery is used as a power source such as for a hybrid vehicle, etc.

Generally, a rechargeable battery includes an electrode assembly including a positive electrode, a negative electrode, and a separator interposed between the positive electrode and the negative electrode, a case to accommodate the electrode assembly, and an electrode terminal electrically connected to the electrode assembly. An electrolyte solution is injected into the case to enable charging and discharging of the battery through an electrochemical reaction of the positive electrode, the negative electrode, and an electrolyte solution. The shape of the case, for example, cylindrical or rectangular, is changed depends on the application of the battery.

The rechargeable battery is used as a battery module formed of a plurality of unit battery cells connected in series and/or parallel to provide high energy density. For example, it may be used to drive a hybrid vehicle motor. That is, the battery module is formed by interconnecting the electrode terminals of the plurality of unit battery cells according to a required amount of power, which may be formed to implement a high power rechargeable battery for an electric vehicle for example.

The battery module may be configured as a block design or a modular design. In the block design, each battery is coupled to a common current collector structure and a common battery management system, and the unit is housed in the case. In the modular design, the plurality of battery cells are connected to form a sub-module, and several sub-modules are connected to form a module. The compatibility of the battery management function may be improved because it may be implemented at least partially in the module or sub-module level. At least one battery module is mechanically and electrically integrated to form the battery system, equipped with a thermal management system, and configured to communicate with at least one electrical consumer.

The mechanical integration of the battery system requires a proper mechanical connection of the individual components (e.g., components of the battery sub-module, between the sub-modules, or the electrical consumer, or the system provided in the vehicle, for example). This connection should be designed to maintain a function under stresses that occur during an average cycle-life and usage of the battery system. At the same time, an installation space and interoperability requirements (particularly for mobile devices) should be satisfied.

The mechanical integration of the battery module may be accomplished by providing a carrier plate, for example a bottom plate, and placing an individual battery cell or sub-module thereon. Fixing of the battery cell or the sub-module may be accomplished, for example, by fitting it in a recess portion of the carrier plate, by mechanical fastening means such as bolts or screws, or by constraining the battery cell or sub-module. The constraint can be achieved by fixing a side plate to the side of the carrier plate and/or by providing another carrier plate to be fixed to the first carrier plate and/or the side plate. Thus, a multi-level battery module may be constructed, wherein the carrier plate and/or the side plate may include a cooling water duct to cool the battery cell or sub-module.

The mechanical integration of the battery sub-module may be achieved either by using a mechanically enhanced electrical connector or by fixing a carrier beam to an electrical connector or the battery cell to a strut. Additionally or alternatively, the sub-module may include a separate casing covering some or all of the surface of the plurality of aligned battery cells. These battery sub-modules are arranged in the battery module, for example on the carrier plate in the separate casing.

The battery sub-module, the battery module, and/or the battery system may include the case for restricting its constituent elements, that is, the battery cell, the battery sub-module, or the battery module. On the other hand, the case should provide protection against environmental impacts, e.g., mechanical, thermal, or electrical impacts. It should also protect the surroundings from dangerous effects of at least one of battery cells that are malfunctioned. In the battery cell level, the case usually includes a metal or plastic to ensure the mechanical protection, the electrical insulation, and the heat dissipation. For some battery types, a flexible pouch may be used instead of a hard cylindrical or rectangular can. The case or pouch typically includes a metal layer to provide mechanical strength and heat dissipation, and may further include an electrically insulating coating on the interior or exterior surface of the metal layer. The pouch according to a conventional art is disclosed in the prior art in US 2006/0083984 A1, and the battery case according to a conventional art is disclosed in KR 20080049548 A1.

At the battery sub-module, battery module, and battery system level, the housing is usually provided as a metal or plastic case made of a metal plate, a fiber-reinforced polymer, or an injection-molded aluminum shell. The case should provide mechanical reinforcement and may include an electrically insulating coating. Because an increase of an internal temperature can cause an abnormal reaction in at least one battery cell, the metal case may be additionally configured to efficiently radiate, emit, and/or dissipate heat generated from the inside thereof. To provide sufficient heat dissipation, the case generally has relatively low wall strength, to reduce the weight of the case.

However, the relatively thin wall of the case of in the battery cells, the battery sub-modules, the battery modules, or the battery systems may be melted by locally increased temperatures, for example due to the malfunctioning of at least one battery cell. Particularly, the malfunctioned battery cell may cause an electric arc that causes a sudden temperature rise in a small area of the case when it hits the case. This arc may damage the case and ultimately break the case. This may lead to a hazardous gas leaking out of the damaged case, making it toxic to the user (e.g., in a car), or cause the gas to ignite and cause additional damage.

### DISCLOSURE

### Technical Problem

One aspect of the present invention provides a wall structure of a case of a battery cell, a battery sub-module, a battery module, or a battery system, which has improved heat dissipation characteristics and improved resistance to an electric arc.

### Technical Solution

One aspect of the present invention relates to a wall structure of a case selected from a group including battery cells, battery sub-modules, battery modules, and battery systems. The wall structure includes a multi-layered structure including a first layer toward an inside of the case, a third layer toward an outside of the case, and a second layer between the first layer and the third layer. In other words, the first layer, the second layer, and the third layer are adjacent to or on each other in ascending order. An additional layer may be on or between the first, second, and third layers so aligned. According to an exemplary embodiment of the present invention, the first layer is configured to electrically isolate the second layer from the inside of the case. That is, the first layer may be an electrical insulating layer including an electrical insulating material. The second layer includes an ablative material and is configured to act as a heat shield for the third layer. That is, the second layer is a thermal insulating layer containing a thermal insulating material, and may be configured to delay heat transfer from the inside (or the first layer) of the case to the outside (or the third layer) of the case. The third layer has higher thermal conductivity than the second layer. Thus, the third layer is configured to distribute heat transmitted from the inside of the case to a wide area (outside the case) of the third layer.

Another aspect of the present invention relates to a battery cell including an electrode assembly, a case to accommodate the electrode assembly, and a cap assembly to seal the opening of the case. The bottom surface and/or the side wall of the case and/or the cap assembly have a multi-layered structure. The multi-layered structure includes a first layer toward the inside of the battery cell, a third layer toward the outside of the battery cell, and a second layer between the first layer and the third layer. In other words, the first layer, the second layer, and the third layer are adjacent to or on each other in ascending order. An additional layer may be on or between the first, second, and third layers so aligned. According to an exemplary embodiment of the present invention, the first layer is configured to electrically isolate the second layer from the electrode assembly. That is, the first layer may be an electrical insulating layer including an electrical insulating material. The second layer includes an ablative material and is configured to act as a heat shield for the third layer. That is, the second layer is a thermal insulating layer containing a thermal insulating material, and may be configured to delay heat transfer from the inside to the outside of the battery cell. The third layer has higher thermal conductivity than the second layer. Thus, the third layer is configured to distribute heat transmitted from the inside of the battery cell to a wide area of the third layer.

Another aspect of the present invention relates to a battery sub-module including a plurality of aligned battery cells and a battery sub-module case. At this time, the battery sub-module case has a pair of sub-module front plates connected to a plurality of opposing sub-module side plates. The battery sub-module case houses a plurality of aligned battery cells. The sub-module front plate and/or the sub-module side plate include a multi-layered structure having a first layer facing a plurality of battery cells, a third layer facing the outside of the battery sub-module case, and a second layer between the first layer and the third layer. In other words, the first layer, the second layer, and the third layer are adjacent to or on each other in ascending order. An additional layer may be on or between the first, second, and third layers so aligned. According to an exemplary embodiment of the present invention, the first layer is configured to electrically isolate the second layer from a plurality of battery cells. That is, the first layer may be an electrical insulating layer including an electrical insulating material. The second layer includes an ablative material and is configured to act as a heat shield for the third layer. That is, the second layer is a thermal insulating layer containing a thermal insulating material, and may be configured to delay heat transfer from the inside of the sub-module case to the outside of the battery sub-module case. The third layer has higher thermal conductivity than the second layer. Thus, the third layer is configured to distribute heat transmitted from the inside of the battery sub-module case to a wide area (outside the battery sub-module case) of the third layer.

Another aspect of the present invention relates to a battery module including a plurality of battery cells and/or a plurality of battery sub-modules in (or above) a battery module case having a bottom plate. The bottom plate or other side wall of the battery module case has a multi-layered structure. The multi-layered structure is a first layer facing a plurality of battery cells and/or a plurality of battery sub-modules, a third layer facing the outside of the battery module case, and a second layer between the first layer and the third layer. In other words, the first layer, the second layer, and the third layer are adjacent to or on each other in ascending order. An additional layer may be on or between the first, second, and third layers so aligned. According to an exemplary embodiment of the present invention, the first layer is configured to electrically isolate the second layer from a plurality of battery cells and/or a plurality of battery sub-modules. That is, the first layer may be an electrical insulating layer including an electrical insulating material. The second layer includes an ablative material and is configured to act as a heat shield for the third layer. That is, the second layer is a thermal insulating layer containing a thermal insulating material, and may be configured to delay heat transfer from the inside of the battery module case to the outside of the battery module case. The third layer has higher thermal conductivity than the second layer. Thus, the third layer is configured to distribute heat transmitted from the inside of the battery module case to a wide area (the outside of the battery module case) of the third layer.

Another aspect of the present invention relates to a battery system including a plurality of battery cells and/or a plurality of battery sub-modules, and/or at least one battery module, and a battery system case. The side wall of the battery system case has a multi-layered structure having a first layer facing a plurality of battery cells and/or a plurality of battery sub-modules and/or at least one battery module, a third layer facing the outside of the battery system case, and a second layer between the first layer and the third layer. In other words, the first layer, the second layer, and the third layer are adjacent to or on each other in ascending order. An additional layer may be on or between the first, second, and third layers so aligned. According to an exemplary embodiment of the present invention, the first layer is configured to electrically isolate the second layer from a plurality of battery cells and/or a plurality of battery sub-modules and/or at least one battery module. That is, the first layer may be an electrical insulating layer including an electrical insulating material. The second layer includes an ablative material and is configured to act as a heat shield for the third layer. That is, the second layer is a thermal insulating layer containing a thermal insulating material, and may be configured to delay heat transfer from the inside of the battery system case to the outside of the battery system case. The third layer has higher thermal conductivity than the second layer. Thus, the third layer is configured to distribute heat transmitted from the inside of the battery system case to a wide area (outside the battery system case) of the third layer.

The case of the battery cell, the sub-module, the module, or the system having the multi-layered structure according to an exemplary embodiment of the present invention may withstand an electrical arc inside the case. The multi-layered structure consists of at least three layers, wherein the first layer faces the inner surface of the case and may be exposed to an arc inside the case in case of failure. The first layer is an electrical insulating layer to prevent additional parts inside the case away from the arc colliding with the case from being short-circuited. To prevent the arc from breaking the case, the second layer is a thermal shield layer containing an ablative material. Physically, the ablative material is configured to dissipate a large amount of thermal energy by sacrificing the material. A plurality of physical processes may participate in such high efficiency heat dissipation, for example carbonization and pyrolysis. The second layer may further have low thermal conductivity. The third layer is configured to provide sufficient mechanical stability to the case, and may be the same as the case of a conventional battery cell, sub-module, module, or system. To further prevent the third layer from becoming mechanically unstable, the third layer has higher thermal conductivity than the thermal conductivity of the second layer to distribute heat passing through the second layer to a wide surface area of the third layer. This reduces a risk of a peak temperature and softening or melting of the third layer.

According to an exemplary embodiment of the present invention, the ablative material of the second layer is configured so as to transition to the ablation process at a threshold temperature of 600° C. or less, preferably 500° C. or less, and particularly preferably 400° C. or less. The ablation process may include a variety of physical processes that occur by reacting with the ablation material that reaches the threshold temperature. The processes include: a phase change such as melting, evaporation, and sublimation; thermal conduction and heat storage of an ablative material matrix; thermal convection in a liquid layer; gas and liquid evaporation; heat absorption from the surface to a boundary layer; and an endothermic chemical reaction. Thus, a type of ablative material is produced in accordance with a predominant ablation mechanism, but other mechanisms may still occur in the material. There are three main types of ablator in the art: a sublimation or melting ablator, a carbonization ablator, and an intumescent ablator.

The intumescent ablator is characterized in that bubbles start to be generated above the critical temperature. A sudden increase in volume associated with the bubbles is difficult to handle in the case structure, and may lead to breakage of the case itself. Thus, the melting ablator and carbonization ablator may be suitable materials for the wall structure according to the present invention. In the carbonization ablator, thermal energy is mainly dissipated by an endothermic reaction. Here, most of the ablative material remains solid. Thus, the carbonization ablator is particularly desirable for the wall structure according to the present invention, but it may be used in combination with the melting ablator as a stiffener.

The second layer may be completely enclosed between the first layer and the third layer. Particularly, the second layer may be completely closed and sealed between the first layer and the third layer in an air-tight manner. This may be achieved by completely forming the entire surface of the case with the first layer, the second layer, and the third layer. Alternatively, the second layer may be partially on the surface of the first layer, and the third layer may be on the entire surface of the first layer and the second layer. Thus, in the periphery of the multi-layered structure, the first layer may directly contact the third layer to cover the second layer in an air-tight manner. By covering the second layer, an oxidation process and/or ignition of an ablation gas at a temperature above the threshold temperature or the decomposition temperature may be avoided. Thus, covering the second layer completely by the first layer and the third layer may be a prerequisite condition to initiate the carbonization and/or pyrolysis of the carbonization ablator. The multi-layered structure according to the present invention may be manufactured by a first step of providing the third layer to the case of a conventional structure (the cell, the sub-module, the module, or the system), a second step of depositing the second layer on the inner surface of the third layer, and a third step of depositing the first layer inside the second layer.

According to an exemplary embodiment of the present invention, the ablative material includes a carbonization ablator having a decomposition temperature of 600° C. or less, preferably 500° C. or less, and particularly preferably 400° C. or less. In other words, the carbonization and/or pyrolysis of the carbonization ablator may be initiated at the decomposition temperature. Due to this low decomposition temperature, the melting or destabilization of the third layer, which is made of aluminum or contains aluminum, may be reliably prevented. Here, the decomposition is related to the reaction temperature at which the endothermic chemical decomposition begins to take place. Therefore, the organic substrate of the pure ablative material is pyrolyzed into a carbonization material and some gas products in the decomposition zone. As a result, char (carbonaceous material produced during the carbonization) is produced from the organic substrate. The dissociation zone separates the pure material from the carbonization zone and passes through the ablative material through the boundary layer. The passage of the boundary layer improves the thermal insulation and reduces the convection heat transfer. In addition, the ablation gas interferes with radiative heat transfer. Therefore, the ablative material acts as a heat sink absorbing almost all incident heat fluxes.

The ablative material of the second layer is configured to react with the electrical arc colliding with the first layer and then to be modified by the ablation process, preferably by the endothermic decomposition such as the carbonization and the pyrolysis. The electrical arc may contain high temperature plasma with a temperature between 5000 K and 50,000 K, limited to a very small volume. Thus, the ablative material of the second layer may also be configured to be modified in the ablation process at a higher temperature, for example, greater than 5000 K, greater than 10,000 K, or greater than 15,000 K. The electrical arc inside the case such as the battery randomly collides with a very small surface area inside the case, and the possibility of the electrical arc colliding repeatedly with the same point is somewhat small. Thus, the local sacrifice of the ablative material reacting with the colliding arc does not significantly change the mechanical stability of the second layer. Thus, the second layer remains mechanically stable during and after arcing in the case as a whole. The third layer has higher thermal conductivity than the second layer. Therefore, the locally increased temperature at the point of the collision is distributed over a wide area of the third layer, and the third layer remains mechanically stable when the electrical arc is generated inside the case as a whole. Therefore, extended cycle-life may be realized by using the wall structure according to an exemplary embodiment of the present invention. However, the case may be replaced after a single fault and an internal arc has occurred.

According to an exemplary embodiment of the present invention, the ablative material is one or more composite materials among graphite, a carbon-fiber-reinforced phenolic, an epoxy resin, a silicon elastomer, Teflon, quartz, cork, and/or nylon. Preferably a silicon elastomer, particularly a foamed silicon elastomer, may be used as the ablative material of the second layer. These carbonization ablator materials can be used in combination with sublimation or melting reinforcement materials. Particularly, the matrix or resin of the carbonization ablator may be filled with particles or fibers of the melting ablator. A silicon elastomer or phenolic material may be used as the matrix material. Particularly, the foamed silicon elastomer may be filled with silicon dioxide and an iron oxide. These materials are decomposed into similar foams of SiO₂, SiC, and FeSiO₃.

Alternatively, the carbonization ablator material may be filled with silica or nylon to provide cooling through evaporation. The carbon-fiber-reinforced phenolic materials are also desirable for the ablative materials in the second layer. Illustratively, the ablative material may include a low density epoxy-novolac resin with phenolic micro-balloons and silica fiber reinforcement to provide a lightweight second layer. In addition, graphite (graphite fiber) reinforced epoxy composites may be used as heat-resistant materials with high cost efficiency and low density. In addition, cork may be used as an ablative material, and glass or mineral particles may be embedded in the matrix of the ablative material such as the silicon matrix. Particularly, a silicon resin containing particles of cork, glass, and phenolic micro-balloons may be used as the ablative material of the second layer.

According to an exemplary embodiment of the present invention, the third layer includes a metal or metal alloy. Particularly, the third layer is made of an alloy of aluminum, iron (Fe), carbon (C), chromium (Cr), and manganese (Mn), and/or an alloy of iron (Fe), carbon (C), chromium (Cr)), and nickel (Ni). Therefore, the third layer may be the same as the case of the conventional battery. The third layer of the metal has good thermal conductivity, thus uniformly distributing the heat generated by the spatially limited electrical arc over a wide area. Depending on the field of use, for example, in the case of a battery cell or a battery system containing hundreds of cells, the third layer has a thickness that assures that the third layer does not easily weaken by responding to the increased temperature. Therefore, the third layer may withstand overpressure of the gas generated inside the case such as the battery.

In addition, a thermally conductive plastic material or resin may be used for the third layer. The material system suitable for the third layer is the same as or similar to the material system suitable for the conventional battery case. The third layer may provide mechanical fixation of the constituent battery elements, mechanical protection of the major constituent elements during an impact, protection against the environment (moisture and dust), EMC shielding, heat distribution in the case of hotspots, containment of a gas that may arise from the cell, and mechanical integrity to the case.

According to an exemplary embodiment of the present invention, the first layer includes a fiber-reinforced plastic material, and is configured to mechanically protect the second layer. The first layer may be electrically insulative, and have flexibility and heat resistance. Because the first layer is electrically insulating, if a conductive part inside the case, for example a bus bar, is deformed toward the case and contacts the case, a short circuit is not generated. Thus, the first layer provides mechanical protection for the second layer, and is configured to prevent the shorting when the bus bar is in contact with the inside of the case. Depending on the usage application, for example, in the case of the battery system containing the battery cell or hundreds of cells, the first layer has a thickness such that the second layer can be reliably isolated from the voltage generated inside the case.

The multi-layered wall structure according to an exemplary embodiment of the present invention is an essential part of the battery case to accommodate the electrode assembly or the cap assembly for sealing the opening of the battery case. According to an exemplary embodiment of the present invention, the first layer is configured to electrically isolate the second layer from the electrode assembly. At this time, the first layer may have a thickness of 20 μm to 50 μm, the second layer may have a thickness of 100 μm to 1 mm, and the third layer may have a thickness of 200 μm to 2 mm.

In addition, the multi-layered wall structure according to an exemplary embodiment of the present invention is an essential part of the battery sub-module case. The battery sub-module case includes a pair of sub-module front plates accommodating a plurality of aligned battery cells and connected to a plurality of sub-module side plates while facing each other. The first layer is configured to electrically isolate the second layer from a plurality of battery cells. In this case, the first layer may have a thickness of 20 μm to 200 μm, the second layer may have a thickness of 400 μm to 4 mm, and the third layer may have a thickness of 0.5 mm to 2 mm.

In addition, a multi-layered wall structure according to an exemplary embodiment of the present invention is an essential part of a battery module case that accommodates a plurality of battery cells and/or a plurality of battery sub-modules. The battery module case includes a bottom plate, and a multi-layered wall structure may be an essential part of the bottom plate. The first layer is configured to electrically isolate the second layer from a plurality of battery cells and/or a battery sub-module. At this time, the first layer may have a thickness of 50 μm to 1 mm, the second layer may have a thickness of 1 to 5 mm, and the third layer may have a thickness of 2 to 10 mm.

In addition, a multi-layered wall structure according to an exemplary embodiment of the present invention is an essential part for receiving a plurality of battery cells and/or a plurality of battery sub-modules, and/or at least one battery module. The first layer is configured to electrically isolate the second layer from a plurality of battery cells and/or a battery sub-module and/or at least one battery module. At this time, the first layer may have a thickness of 50 μm to 2 mm, the second layer may have a thickness of 1 mm to 10 mm, and the third layer may have a thickness of 2 mm to 50 mm.

### Advantageous Effects

According to an exemplary embodiment of the present invention, at least one of the battery cell, the battery sub-module, the battery module, and the battery system has the multi-layered wall structure, thereby having the improved heat dissipation characteristics and the improved resistance to the electrical arc.

### DESCRIPTION OF THE DRAWINGS

FIG. 1 is a schematic perspective view of a battery cell according to an exemplary embodiment of the present invention.

FIG. 2 is a schematic cross-sectional view of a battery cell including a multi-layered wall structure according to an exemplary embodiment of the present invention.

FIG. 3 is a schematic perspective view of a battery sub-module including a multi-layered wall structure according to an exemplary embodiment of the present invention.

FIG. 4 is a schematic perspective view of a battery module case including a multi-layered wall structure according to an exemplary embodiment of the present invention.

FIG. 5 is a schematic perspective view of a battery system including a multi-layered wall structure according to an exemplary embodiment of the present invention.

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Also, as used herein, the term “and/or” includes any plurality of combinations of items or any of a plurality of listed items. That is, in this specification, ‘A and/or B’ may include ‘A’, ‘B’, or ‘both A and B’.

In this specification, terms such as ‘first’, ‘second’, etc. are used to describe various constituent elements, regions, layers, and/or sections, but these constituent elements, regions, layers, and/or sections are not limited to these terms. It will be understood that when an element such as a layer, film, region, or substrate is referred to as being “on” another element, it can be directly on the other element or intervening elements may also be present. It will be understood that when an element such as a layer, film, region, or substrate is referred to as being “under” or “below” another element, it can be directly under the other element or intervening elements may also be present

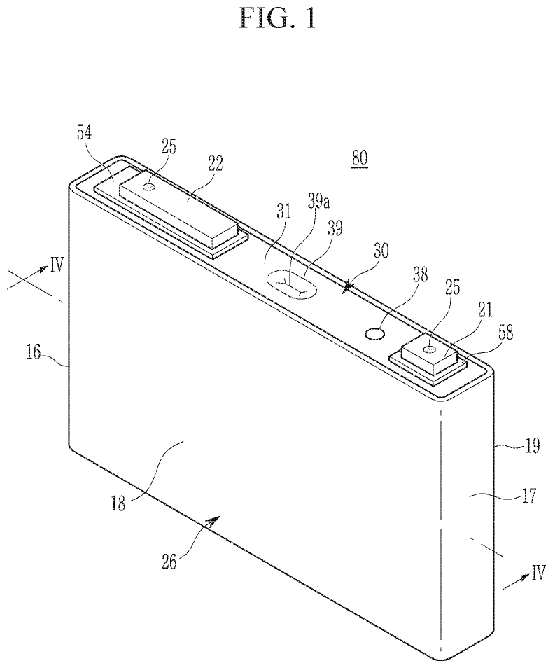

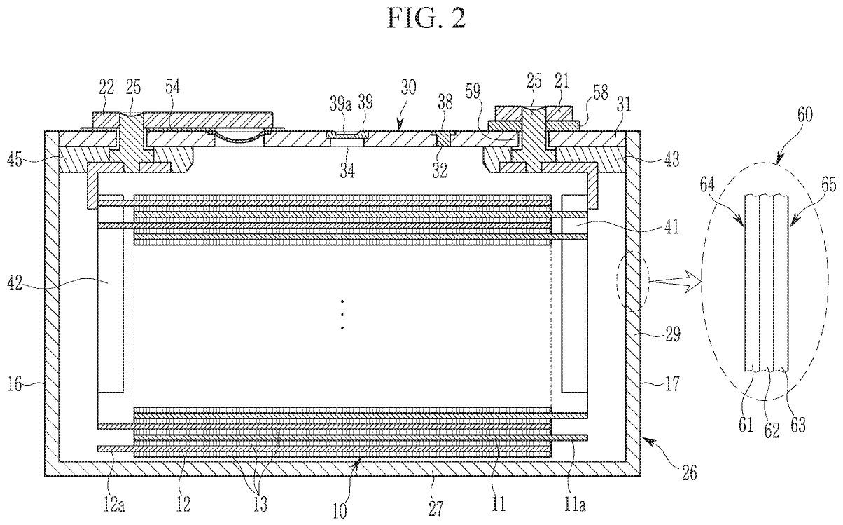

FIG. 1 is a perspective view of a battery cell according to an exemplary embodiment of the present invention, and FIG. 2 is a cross-sectional view taken along a line IV-IV of FIG. 1. Referring to FIG. 1 and FIG. 2, a battery cell 80 according to an exemplary embodiment of the present invention includes an electrode assembly 10 and a case 26 for receiving the electrode assembly 10 and an electrolyte solution. The battery cell 80 may also include a cap assembly 30 for sealing an opening of the case 26. The battery cell 80 is described as a prismatic lithium ion secondary battery, but is not limited thereto.

The electrode assembly 10 may be an electrode assembly of a jelly-roll type in which a positive electrode 11 and a negative electrode 12 are spiral-wound via a separator 13 interposed therebetween. The positive electrode 11 and the negative electrode 12 may include a coating area of a current collector formed of a thin metal foil on which an active material may be coated, and the active material may not be coated on positive and negative uncoated regions 11 a and 12a of the current collector.

The positive electrode uncoated region 11 a may be at one end of the positive electrode 11 in the length direction, and the negative uncoated region 12a may be at one end of the negative electrode 12 in the length direction. The electrode assembly 10 may have a structure including a plurality of sheets in which the positive electrode 11, the separator 13, and the negative electrode 12 are repeatedly stacked.

The electrode assembly 10 may be housed in the case 26 with the electrolyte solution. The electrolyte solution may be made of lithium salts such as LiPF₆ or LiBF₄ by using organic solvents such as EC, PC, DEC, EMC, and EMC. The electrolyte solution may be in a liquid, solid, or gel state. The case 26 may have a substantially rectangular parallelepiped shape, and an opening may be on one side thereof.

The case 26 may include a bottom surface 27 with a substantially rectangular shape, and a pair of first side walls (or wide sides) 18 and 19 and a pair of second side walls (or narrow sides) 16 and 17, such that a space for accommodating the electrode assembly 10 may be provided. The first side walls 18 and 19 may face each other, and the second side walls 16 and 17 may face each other. The length of the edge where the bottom surface 27 and the first side walls 18 and 19 are connected to each other may be longer than the length of the edge where the bottom surface 27 and the second side walls 16 and 17 are connected to each other. The first and second side walls adjacent to each other may be form an angle of 90°.

The cap assembly 30 may include a cap plate 31 coupled to the case 26 and covering the opening of the case 26, and a positive electrode terminal 21 and a negative terminal 22 electrically connected to the positive electrode 11 and the negative electrode 12 provided outside the case 26 and protruding from the cap plate 31. The cap plate 31 may include an inlet 32 and a vent hole 34 communicating with the inside of the cap assembly 30. The inlet 32 may allow the electrolyte solution to be injected, and a sealing cap 38 may be installed in or on the inlet 32. In addition, the vent hole 34 may be provided with a vent member 39 with a notch 39a that may be ruptured at a predetermined pressure.

The positive electrode terminal 21 may be electrically connected to the positive electrode 11 through a current collecting tab 41, and the negative terminal 22 may be electrically connected to the negative electrode 12 through a current collecting tab 42. A sealing gasket 59 may be mounted between a terminal connection member 25 and the cap plate 31. A lower insulating member 43 into which a lower portion of the terminal connection member 25 is inserted may be installed below the cap plate 31. A connection plate 58 for electrically connecting the positive electrode terminal 21 and the cap plate 31 may be mounted between the positive electrode terminal 21 and the cap plate 31.

The negative terminal 22 and the current collecting tab 42 may be electrically connected to each other. A sealing gasket similar to the gasket 59 described above may be mounted between the negative terminal 22 and the cap plate 31. An upper insulating member 54 for electrically isolating the negative terminal 22 and the current collecting tab 42 from the cap plate 31 may be mounted between the negative terminal 22 and the cap plate 31.

As shown in FIG. 2, a side wall 29 of the battery case 26 may have a multi-layered structure 60 according to an exemplary embodiment of the present invention. The bottom surface 27 or the cap assembly 30 may also have a multi-layered structure 60 according to an exemplary embodiment of the present invention. Here, the side wall 29 includes the first side walls 18 and 19 and the second side walls 16 and 17 of the battery cell case 26, and is collectively referred to as a side wall 29 for convenience of explanation.

As shown in FIG. 2, the side wall 29 includes a first layer 61 toward the inside 64 of the side wall 29 and facing the electrode assembly 10. The first layer 61 is an electrical insulation material such as cast polypropylene (CPP), and may have a thickness of 25 μm. The first layer 61 is configured to isolate subsequent layers of the multi-layered structure 60 from an electrical arc or spark generated within the case 26 by the electrode assembly 10.

The multi-layered structure 60 further includes a third layer 63 toward the outside 65 of the battery cell 80. The third layer 63 is made of aluminum has a thickness of 0.8 mm, and provides mechanical stability to the battery cell case 26. Particularly, the third layer 63 is configured to resist a pressure within the battery cell 80 below a threshold pressure that actuates the vent member 39. The third layer 63 also has high thermal conductivity.

The multi-layered structure 60 further includes a second layer 62 which is completely enclosed between the first layer 61 and the third layer 63 and includes an ablative material. The second layer 62 contains a silicone resin matrix with a thickness of 0.5 mm containing nylon particles in the matrix. The second layer 62 is configured to be modified in an ablation process at a threshold temperature of about 400° C. Therefore, at a temperature above 400° C., the ablative material is pyrolyzed and begins to change to char (a carbonaceous material generated in carbonization), thereby protecting the third layer 63.

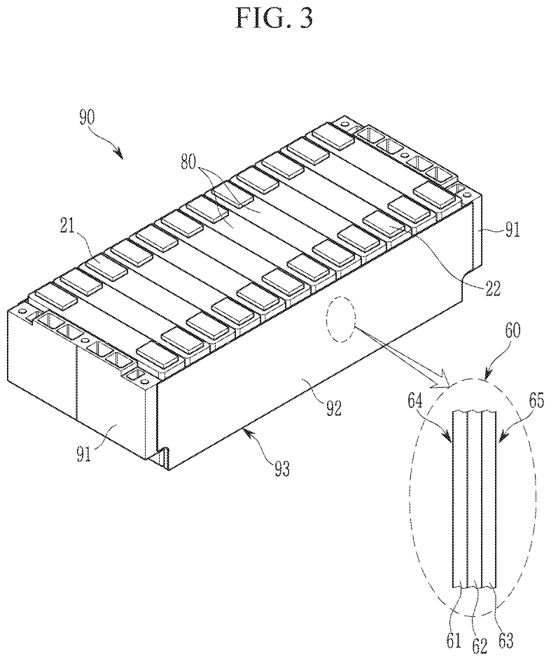

Referring to FIG. 3, a battery sub-module 90 according to an exemplary embodiment of the present invention includes a plurality of aligned secondary battery cells 80 of a plan view shown in FIG. 1 and FIG. 2. The battery cells 80 are aligned so the first sides 18 and 19 of the adjacent battery cells 80 face each other. A pair of sub-module front plates 91 are mechanically coupled to a pair of sub-module side plates 92 facing the second sides 16 and 17 of the battery cell 80. The sub-module front plates 91 and the sub-module side plates 92 constitute a case 93 of the battery sub-module 90. The positive electrode terminal 21 and the negative terminal 22 of the adjacent battery cell 80 may be electrically connected through a bus bar (not shown). Thus, the battery sub-module 90 can be used as a power source unit by electrically connecting a plurality of battery cells 80 as a bundle.

As shown in FIG. 3, the sub-module side plate 92 includes the multi-layered structure 60 according to an exemplary embodiment of the present invention. The sub-module front plate 91 may also include the multi-layered structure 60. The multi-layered structure 60 has the inside 64 of the sub-module side plate 92 and the first layer 61 facing the narrow side (the second side wall: 16, 17) of the aligned battery cell 80. The first layer 61 is made of an electrically insulating plastic material such as a polyamide or polypropylene, and may have the thickness of 0.1 mm. Thus, the first layer 61 may have a thickness that may electrically isolate the subsequent layers (the second and third layers 62, 63) from the electrical arc created by the at least one aligned battery cell 80. The multi-layered structure 60 includes a third layer 63 made of a thermally conductive sheet material such as a thermo-conductive polymer, or steel or aluminum, and has a thickness of 1 mm. Thus, the third layer 63 is configured to mechanically stabilize a plurality of battery cells 80 in the event of an external environmental impact.

The second layer 62 is completely enclosed between the first layer 61 and the third layer 63, and may include a graphite (or a graphite fiber) reinforcement epoxy composite that has a thickness of 2 mm as the ablative material. Because the melting temperature of the third layer 63 is approximately 600° C., the second layer 62 is modified in an ablation process, e.g., the carbonization of the epoxy compound, at the threshold temperature sufficiently below the melting temperature. Thus, the second layer 62 is configured to shield heat from the third layer 63 from the electrical arc colliding on the first layer 61.

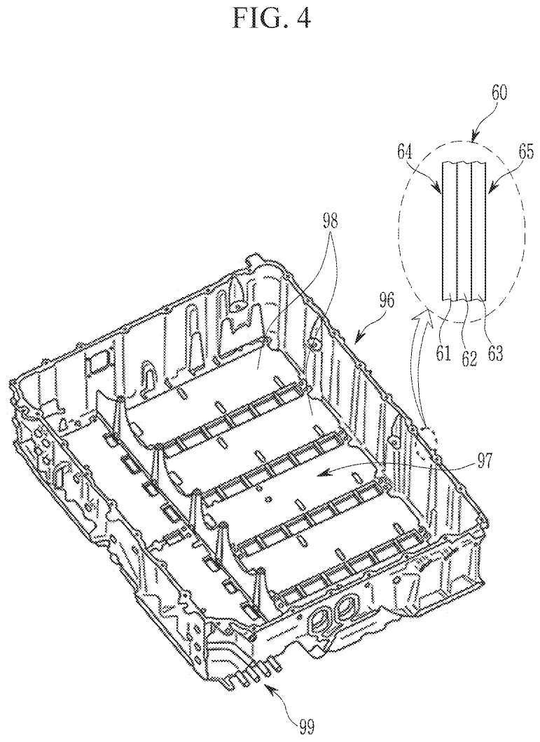

A plurality of battery sub-modules 90 shown in FIG. 3 may be in a case 96 (referring to FIG. 4) of the battery module to form the battery module. FIG. 4 is a view of the battery module case 96 including a bottom plate 97 in which the battery cell 80 is disposed according to an exemplary embodiment. Particularly, the bottom plate 97 includes a plurality of assembly regions 98, wherein one battery sub-module 90 is arranged in each assembly region 98. The bottom plate 97 may further include a cooling tube 99 integrally incorporated in the bottom plate 97. The side wall or the bottom plate of the battery module case 96 may include the multi-layered structure 60 according to an exemplary embodiment of the present invention.

As shown in FIG. 4, the side wall of the battery module case 96 includes the multi-layered structure 60 having the first layer 61 toward the inside 64 of the battery module case 96 according to an exemplary embodiment of the present invention. The first layer 61 may have the thickness of 1 mm to provide sufficient electrical insulation for the electrical arc that may be caused by at least one failed cell of the battery module. The third layer 63 may be made of cast aluminum with a thickness of 0.7 cm facing the outside 65 of the battery module case 96. In this case, the thickness may be determined such that it is sufficient to provide mechanical stability to a plurality of battery cells and/or the battery sub-modules in the assembly region 98. The cooling tube 99 may be embedded in the third layer 63. The second layer 62 is completely surrounded by the first layer 61 and the third layer 63, and includes a silicon resin which is a matrix of a carbonization ablative material containing a nylon fiber which is the melting ablator. The second layer 62 may have a thickness of 4 mm to provide sufficient thermal shielding for the electrical arc that may be generated by at least one failed cell of the battery module.

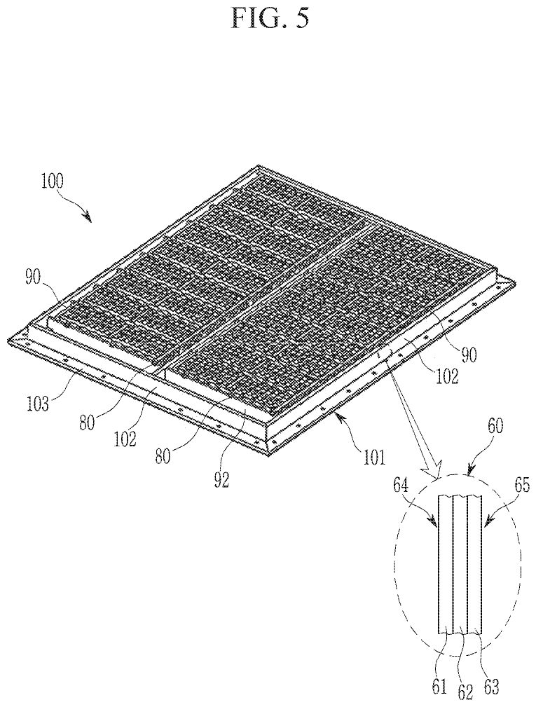

Referring to FIG. 5, the battery system 100 according to an exemplary embodiment of the present invention includes the plurality of battery sub-modules 90 shown in FIG. 3. The battery sub-modules 90 of four columns respectively including nine battery sub-modules 90 are in a case 101 of the battery system 100. The battery system case 101 may include a side wall 102, a bottom plate 103 welded to the side wall 102, and a cover (not shown). The battery system 100 includes a first and/or second electrical and/or electronic box (E/E box, not shown) for controlling a voltage and current of the battery sub-module 90. The electrical and electronic box may include a battery management unit (BMU), a high voltage connector, an input, a fuse, a relay, a current sensor, an EMC filter, a precharge relay, a resistor, and/or an HV interface.

At least one of the side wall 102, the bottom plate 103, and the cover (not shown) of the battery system case 101 may include the multi-layered structure 60 according to an exemplary embodiment of the present invention.

As shown in FIG. 5, at least one side wall 102 of the battery system case 101, preferably both side walls 102, includes the first layer 61 facing the inside 64 of the battery system case 101 and the plurality of battery sub-modules 90. The first layer 61 is an electrical insulation material consisting of a mixture of ceramic particles and an adhesive resin, and the thickness thereof may be 2 mm. Thus, the first layer 61 is configured to electrically shield the second layer 62 and the third layer 63 from the electrical arc generated by the at least one malfunctioned battery sub-module 90. The third layer 63 of the multi-layered structure 60 is made of an extruded aluminum profile with a thickness of 2 cm, and faces the outside of the battery system case 101. Thus, the side wall 102 is suitable to be assembled into the battery system case 101 to provide mechanical integrity to the battery system 100. The second layer 62 is completely surrounded by the first layer 61 and the third layer 63 and may include phenolic micro-balloons, for example a phenolic substance, or may include a silicon resin including microscopic spheres as an ablative material. The second layer 62 may have a thickness of 5 mm to provide sufficient thermal shielding for the electrical arc that may be generated by at least one failed sub-module 90 of the battery system 100.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100 battery system

90 battery sub-module

80 battery cell

10 electrode assembly

11 positive electrode

12 negative electrode

13 separator

18, 19 first side wall

16, 17 second side wall

21 positive electrode terminal

22 negative terminal

27 bottom surface

29 battery case side wall

30 cap assembly

31 cap plate

32 inlet

34 vent hole

38 sealing cap

39 vent member

41, 42 current collecting tab

43, 45 lower insulating member

54 upper insulating member

58 connection plate

59 gasket

60 multi-layered structure

61 first layer

62 second layer

63 third layer

91 sub-module front plate

92 sub-module side plate

93 sub-module case

96 battery module case

97 bottom plate

98 assembly region

99 cooling tube

101 battery system case

102 battery system side wall

103 battery system bottom plate

1. A wall structure of one case among a battery cell, a battery sub-module, a battery module, and a battery system, comprising
a multi-layered structure having a first layer toward an inside of the case, the case, a third layer toward an outside of the case, and a second layer between the first layer and the third layer,
wherein the first layer is configured to electrically isolate the second layer from the inside of the case,
the second layer includes an ablative material and is configured to act as a heat shield for the third layer, and
the third layer has higher thermal conductivity than the second layer.

2. The wall structure of claim 1, wherein
the ablative material is modified in an ablation process at a temperature below 600° C.

3. The wall structure of claim 1, wherein
the ablative material is modified in an ablation process by reacting to an electrical arc colliding on the first layer.

4. The wall structure of claim 2, wherein
the ablation process includes pyrolysis or carbonization of the material in the second layer.

5. The wall structure of claim 1, wherein
the second layer is completely surrounded between the first layer and the third layer.

6. The wall structure of claim 1, wherein
the ablative material includes one or a complex thereof among graphite, a carbon-fiber-reinforced phenolic, an epoxy resin, a silicone elastomer, Teflon, quartz, cork, and nylon.

7. The wall structure of claim 1, wherein
the third layer includes a metal or a metal alloy.

8. The wall structure of claim 7, wherein
the third layer includes at least one among alloys of aluminum, iron (Fe), carbon (C), chromium (Cr), and manganese (Mn), and alloys of iron (Fe), carbon (C), chromium (Cr), and nickel (Ni).

9. The wall structure of claim 1, wherein
the third layer is configured to provide mechanical integrity to the case.

10. The wall structure of claim 1, wherein
the first layer includes a fiber-reinforced plastic material.

11. The wall structure of claim 1, wherein
the material of the first layer has a melting point of 200° C. or higher.

12. A case of a battery cell for receiving an electrode assembly or a cap assembly for sealing an opening of the case, and including the wall structure according to claim 1,
wherein the first layer is configured to electrically isolate the second layer from the electrode assembly.

13. A battery sub-module case receiving a plurality of aligned battery cells and including a pair of sub-module front plates connected to a plurality of sub-module side plates, and including the wall structure according to claim 1,
wherein the first layer is configured to electrically isolate the second layer from the plurality of battery cells.

14. A battery module case receiving at least one of a plurality of battery cells and a plurality of battery sub-modules and including a bottom plate, and including the wall structure according to claim 1,
wherein the first layer is configured to electrically isolate the second layer from at least one of the plurality of battery cells and the plurality of battery sub-modules.

15. A battery system case receiving at least one among a plurality of battery cells, a plurality of battery sub-modules, and at least one battery module, and including the wall structure according to claim 1,
wherein the first layer is configured to electrically isolate the second layer from at least one of the plurality of battery cells, the plurality of battery sub-modules, and at least one battery module.

16. The wall structure of claim 3, wherein
the ablation process includes pyrolysis or carbonization of the material in the second layer.
